(19) United States
(12) Patent Application Publication
(10) Pub. No.: US 2011/0266123 A1
(43) Pub. Date: Nov. 3, 2011

(54) CONTROL ELEMENT CAP AND METHOD FOR PRODUCING SAID CONTROL ELEMENT CAP

(75) Inventor: Martin Jeitner, Ostheim (DE)

(73) Assignee: PREH GMBH, Bad Neustadt a. d. Saale (DE)

(21) Appl. No.: 13/140,121

(22) PCT Filed: Dec. 3, 2009
(86) PCT No.: PCT/EP09/66366

§ 371 Date: Jul. 19, 2011

(30) Foreign Application Priority Data
Dec. 16, 2008 (DE) 10 2008 062 579.5

(51) Int. Cl. H01H 13/14; B32B 37/00

(52) U.S. Cl. 200/312; 156/275.5

(57) ABSTRACT

The invention relates to a control element cap. Such control element caps are used, for example, for switches and/or keys in motor vehicles. In the known control element caps, the representation of a symbol is relatively diffuse and thus not always recognizable with a sufficient degree of reliability. Therefore, a control element cap is to be provided in which the sharpness, and thus the clearness of the symbol is improved; this is accomplished by a transparent carrier plate being disposed between a foil and a display, luminous or projection surface.

The invention further relates to a manufacturing process associated therewith.

### TECHNICAL FIELD

The invention relates to a control element cap and a method for producing the same.

### BACKGROUND

Such control element caps are used, for instance, in a motor vehicle. The control element cap comprises a cap body and a display, luminous or projection surface disposed therein which is visible to the operator only when an associated light source is switched on. The display surface serves for displaying a symbol which, for example, informs the operator about which control or regulating device can be operated by means of the control element. In particular, the display surface can serve for furnishing information on the switching status of the control element or the switching status of the devices activated by the control element, or it may serve for furnishing information on the states of the devices connected with the control element, for example in order to display a malfunction of the devices.

It is known to provide a control element cap with a luminous or projection surface for the aforementioned purposes. To this end, display or projection surfaces of transparent plastic are most frequently inserted into control element covers that are configured in accordance with the desired symbol and which are visible to an operator when illuminated by means of a correspondingly disposed light source. These known control element cap have some drawbacks, in particular if another important information is to be presented dependent upon whether or not the display surface is illuminated. Most of the time, the symbol in the known control element caps is thus already clearly visible in daylight even if the light source is switched off, in particular in the case of direct exposure to sunlight, that is, incident light. Thus, the difference of whether the symbol is actually illuminated, that is, whether the device activated by means of the control element is switched on and whether there is a malfunction, is not discernible for the operator in this light. Thus, the difference between a locator and a functional lighting cannot be clearly discerned in all possible lighting conditions. Thus, the information transfer is not reliable, and incorrect information cannot be avoided with certainty. From the standpoint of safety considerations, this is cause for concern in a motor vehicle. Furthermore, a symbol on the luminous or projection surface that is still visible despite the light source of the control element being switched off has the drawback that the operator is inundated with information that currently has no relevance. In order to avoid this, a symbol on the display surface that, when the light source is switched off, is as unobtrusive as possible, that is, does not appear, is desired in addition to the esthetically advantageous effect.

A control element cap in which a symbol is visible and which takes on a different color when backlighted is known from EP 622585 A1. A transparent basic body of the control element cap is coated with a transparent external control surface. An opaque layer, into which the symbol is incorporated in such a way that the layer is completely removed there, so that the symbol is translucent, is disposed between the basic body and the coating. Two differently colored foils are located between the symbol and the basic body. This control element cap has the drawback that the symbol is clearly visible even without backlighting.

DE 10 2007 018 905 A1 discloses a control element cap of a switch in which a symbol is only visible if backlighted. The control element cap comprises a keycap in which a symbol can be displayed on a luminous or projection surface when a light source disposed in the control element is switched on. The luminous or projection surface comprises a foil with light-refractive microspheres. The drawback of this control element cap is that inhomogeneities may occur in the symbol.

### BRIEF SUMMARY

Based on DE 10 2007 018 905 A1, the invention provides a control element cap in which the sharpness and thus the perceptibility of the symbol is improved.

The invention further provides a method for producing the control element cap.

The control element cap according to the invention is intended for covering and/or actuating a switch or a key or a rotating actuator of an associated control element. Together with other components, the control element cap forms the control element. For example, the control element cap can also be integrated into an operating plate or a dashboard of a motor vehicle.

In the cap body, a display surface is configured in such a way that a symbol displayed on a display, luminous or projection surface is visible to an operator of the control element only by way of illumination by means of a light source disposed on the switch side. Once the light source has gone out, the symbol is invisible. The display surface comprises an opaque layer and a foil comprised of a plurality of light-refractive microspheres and containing an opaque matrix. The microspheres are connected to the substrate in optical contact.

The opaque layer is applied in the cap body and forms a mask into which the symbol is incorporated. Thus, the mask is a screen with a light transmitting opening, the shape of which corresponds to the design of the symbol to be presented. By applying the mask directly onto the luminous surface, a particularly sharply contoured representation of the symbol is accomplished.

The microspheres are, for example, glass microspheres having a diameter of about 60 μm and a refractive index of about 1.5.

The substrate preferably is a transparent polymer material.

The opaque matrix is preferably a colored polymer material layer provided with a binding agent into which the microspheres are embedded.

The foil preferably is the Vikuiti® XRVS foil, which is produced by 3M Corporation and described in EP 0 974 072 B1, which is hereby incorporated by reference.

The microspheres act as lenses for collecting the light projected by the light source onto the foil. Due to the amplifying effect of the lenses, a particularly high light intensity of the symbol displayed in the mask, and thus on the display surface, is thus accomplished. Thus, the symbol is clearly recognizable in the illuminated state even at high ambient light intensity and also under an unfavorable angle of view. Since the microspheres are embedded into the opaque matrix, an optical screen forms around every microsphere. Due to the opaque coloration of the matrix, it absorbs ambient light incident from the side of actuation. The foil and thus the luminous or projection surface, depending on the coloration of the opaque matrix, shows itself as a correspondingly colored surface when the light source is switched off. In the case of a matrix colored black, the absorption of ambient light is particularly pronounced and the luminous or projection surface appears to be black; this is also known as a “black plate” display. Due to the absorption of the ambient light by the foil when the light source is switched off, the display surface does not become visible.

The light coming from the light source of the control element passes the light-refractive microspheres and the substrate. This causes an increase in intensity of the light coming from the light source in the area of the luminous or projection surface, and thus a good brightness of the symbol produced. Thus, the difference between the illuminated and non-illuminated symbol is clearly recognizable even at a particularly high ambient light intensity. Due to the fact that the symbol cannot be seen in the non-illuminated state even at a high intensity of the ambient light and that the operator is not bothered with currently irrelevant information, the operator is not inundated and confused with too much information, in addition to the esthetically advantageous impression connected therewith. Thus, information is transferred to the operator only if required, for example in the case of a function being switched on.

According to the invention, a transparent carrier plate is disposed between the foil and the mask. A predetermined distance between the foil and the mask is thus maintained. This causes the light exiting the microspheres being more strongly scattered when it is incident upon the mask than without a distance. Individual light beams exiting the microspheres merge into one another so that the light intensity on the mask displaying the symbol is very uniform. Here, the individual light beams are indistinguishable from one another. On the whole, the backlighted symbol thus appears sharper and is more easily visible. Incorrect information of the operator and possible operating errors are avoided. The required luminance of the lighting means is low.

In an advantageous embodiment, the symbol is generated by means of an opaque lacquer, which is removed section by section, for example by means of laser processing. The cap according to the invention can thus be produced particularly inexpensively. Any symbols can be presented on the cap because of the very flexible processing options due to the laser.

Alternatively, the symbol is imprinted on the inner side of the cap.

It is easily and inexpensively possible to glue the foil onto the carrier plate.

This also applies to gluing the carrier plate into the keycap by means of a transparent adhesive. The latter does not adversely affect the guidance of light to the symbol. The carrier plate is glued in with the foil having been glued to it in advance, which on the whole makes the assembly simpler.

The same applies, mutatis mutandis, for the method according to the invention.

### BRIEF DESCRIPTION OF THE DRAWING

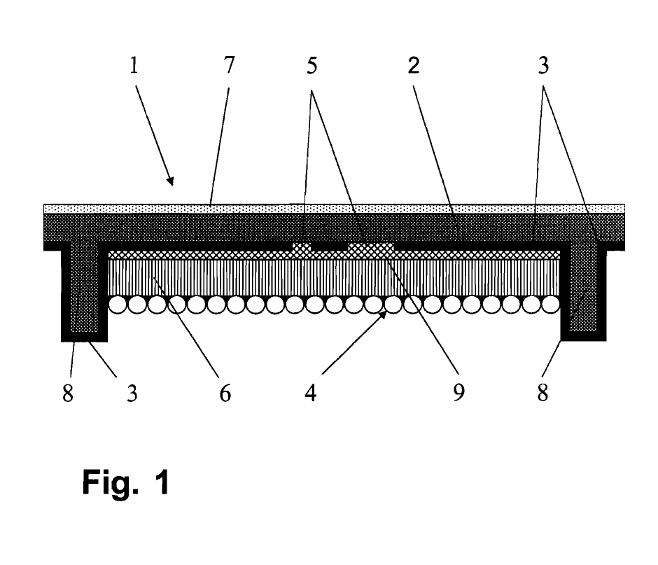

A preferred embodiment of a control element cap according to the invention is shown in the attached figure, without limiting the invention thereto. The only FIG. 1 shows a schematic cross-section of the control element cap.

### DETAILED DESCRIPTION

As is apparent from FIG. 1, a control element cap 1 comprises a transparent cap body 2 produced by an injection-molding process from a suitable plastic, such as polycarbonate or polymethylmetacrylate, for example Lexan®. The plastic is preferably provided colored. The cap body 2 largely has the shape of a rectangular parallelepiped with an open side, which in FIG. 1 points in a downward direction. An opaque lacquer 3 is applied at least on inner sides of the cap body 2. On the inner side facing the switch, the lacquer 3, in order to produce a mask presenting the symbol 5, is engraved accordingly over its entire thickness, for example by means of a laser. This means that the symbol 5 is configured to be translucent in the lacquer. Grooves that are not shown and which extend in a direction from the bottom to the top are let into inner sides of (according to FIG. 1, vertical) side walls of the cap body 2.

The cap body 2 is coated with a transparent protective lacquer 7 on the side facing the operator, which in FIG. 1 is the top side. The lacquer is shiny and as resistant as possible against mechanical and chemical influences.

As an alternative to the mask formed from the lacquer 3 and the engraved symbol 5, the mask is produced by a printed opaque color. This means that the inner sides of the cap body are painted opaque, with the symbol 5, as a negative, being free from color.

A transparent carrier plate 6 is glued into the cap body 2 in such a way that is largely flush with the side parts 8 of the cap body 2 and has a small distance to the mask. Between the mask or an underside of the cap body 2 and the carrier plate 6, there is a transparent UV curable adhesive 9 which compensates bumps in the lacquer 3 and which is free from inclusions of air, in particular in the area of the symbol 5.

A foil 4 is glued onto the carrier plate 6 on an outer side facing in the downward direction. The foil 4, which is only shown schematically in FIG. 1, comprises a transparent substrate, a plurality of light-refractive microspheres that are connected to the substrate in an optical contact, and an opaque matrix into which the microspheres are embedded.

In the assembled state, a light source which is not shown is located underneath the control element cap 1. Light from this light source penetrates the foil 4, the carrier plate 6 as well as the adhesive 9 and shines through the engraving representing the symbol 5. The latter is visible from the side of the operator through the protective lacquer 7 and the cap body 2, with a luminance and a sharpness of the symbol 5 being particularly high due to the optical effect of the foil 4 in conjunction with the carrier plate 6. When the light source is switched off, the symbol 5 does not appear due to the absorptive effect of the foil 4 with regard to light incident from the side of the operator.

The control element cap 1 is produced as follows:

First, the cap body 2 is produced by means of a two-component injection molding technique. In order to form a symbol, the inner side is coated with a lacquer 3, and the symbol 5 is engraved into the inner side by means of a laser beam. In case the mask is formed in an alternative manner, the inner sides are printed accordingly.

Parallel or subsequently, the carrier plate 6 is cut from a pane of corresponding thickness, with the foil 4 having been laminated onto the pane in advance.

A defined quantity of the adhesive 9 is applied approximately centrally on the predetermined inner side of the cap body 2. The carrier plate 6 with the foil 4 laminated thereon is then pressed into the cap body 2 in such a way that the foil faces outwards. In the process, the adhesive 9 distributes uniformly over the entire surface of the predetermined inner side while air is being displaced and discharged through the grooves. It is thus accomplished that the adhesive is free from inclusions of air. Finally, the top of the keycap 2 is coated with the protective lacquer 7.

1. Control element cap, comprising
a cap body for covering and/or actuating a switch,
wherein, in the cap body, a display, luminous or projection surface is configured in such a way that a symbol displayed on or by the display, luminous or projection surface is visible to an operator of the control element only by way of illumination by means of a light source disposed on the switch side,
wherein the display, luminous or projection surface comprises a mask into which the symbol is incorporated, and a foil which includes a transparent substrate, a plurality of light-refractive microspheres connected in optical contact with the substrate, and an opaque matrix into which the microspheres are embedded, and
wherein a transparent carrier plate is disposed between the foil and the mask.

2. Control element cap according to claim 1, wherein the mask is formed from an opaque lacquer.

3. Control element cap according to claim 1, wherein the mask is printed on.

4. Control element cap according to any claim 1, wherein the foil is glued onto the carrier plate.

5. Control element cap according to claim 1, wherein the carrier plate is glued into the cap body by means of a transparent adhesive.

6. Method for producing a control element cap, comprising
producing a cap body from a transparent plastic by means of two-component injection molding;
laminating a carrier plate with a foil,
applying a symbol onto an inner side of the cap body, either by being printed on as a negative with an opaque printing ink, or by an opaque lacquer being applied into which the symbol is engraved through to the cap body,
applying transparent UV curable adhesive in the cap body,
pressing the carrier plate into the cap body and onto the glue,
curing the glue by means of UV radiation, and
coating the cap body with a transparent protective lacquer on a side facing the operator.
